(19) United States
(12) Patent Application Publication
(10) Pub. No.: US 2018/0087684 A1
(43) Pub. Date: Mar. 29, 2018

(54) FLUID CONTROL SYSTEM AND JOINT BLOCK USED THEREFOR

(71) Applicant: FUJIKIN INCORPORATED, Osaka (JP)

(72) Inventors: Shinya Nogari, Osaka-shi (JP); Takahiro Matsuda, Osaka-shi (JP)

(21) Appl. No.: 15/277,053

(22) Filed: Sep. 27, 2016

(51) Int. Cl. F16K 27/00; G05D 7/06

(52) U.S. Cl. CPC F16K 27/00; G05D 7/0617

(57) ABSTRACT

A fluid control system is provided in which the number of bolts is greatly reduced so that the number of assembling steps can be decreased. The system has first and second joint blocks with engagement portions respectively, a support mechanism having a guide portion engageable with each of the blocks, and a fluid device including a body that defines a fluid channel having first and second channel ports opened on a bottom surface thereof, the blocks are restrained on the support mechanism while being movable in the longitudinal direction when the engagement portions are engaged with the guide portion respectively, and the body of the fluid device is installed on the upper surfaces of the blocks so that the channel ports of the body are communicated with the channel ports on the upper surfaces of the blocks, respectively, and the body is connected with the blocks by fastening members, respectively.

### BACKGROUND OF THE INVENTION

### 1. Field of the Invention

The present invention relates to a fluid control system and a joint block used therefor.

### 2. Description of Related Art

In a semiconductor manufacturing process and others, to supply an accurately measured process gas into a process chamber, a fluid control system called an integrated gas system (IGS®) having various kinds of fluid devices such as an opening/closing valve, a mass flow controller, and the like integrated and accommodated in a box is used. Further miniaturization of this fluid control system has been demanded in the light of a reduction in running cost and others.

Japanese Unexamined Patent Application Publication No. 2002-206700 discloses that fluid devices arranged in a line along a longitudinal direction are coupled with each other through a joint block, a plurality of assemblies each having the joint block disposed to a rail member are formed, and the plurality of assemblies are arranged side by side on a base plate.

In the above-described publication, a slider fitted on the rail member and the joint block are coupled through bolts, and the joint block is fixed to the rail member by using fastening force of the bolts.

Thus, in the entire device, an enormous number of bolts are required, and the number of bolt fastening steps at the time of assembling each assembly is also considerable.

### SUMMARY OF INVENTION

One of objects of the present invention is to provide a fluid control system that enables greatly reducing the number of components, especially the number of bolts and decreasing the number of assembling steps, and to provide a joint block suitable therefor.

According to the present invention, there is provided a fluid control system including:

A fluid control system comprising:

first and second joint blocks that define an upper surface, a bottom surface opposite to the upper surface, and a side surface extending from the upper surface toward the bottom surface, also define a fluid channel with a channel port opened on the upper surface, and have an engagement portion, respectively;

a support mechanism that has a guide portion extending in a longitudinal direction, the guide portion being engageable with each of the engagement portions of the first and second joint blocks; and

a fluid device that has a body defining a fluid channel with first and second channel ports opened on a bottom surface thereof,

wherein the engagement portions are engaged with the guide portion of the support mechanism, respectively, so that the first and second joint blocks are restrained on the support mechanism while being movable along the longitudinal direction, and

the body of the fluid device is installed on the upper surfaces of the first and second joint blocks so that the first and second channel ports of the body are communicated with the channel ports in the upper surfaces of the first and second joint blocks, respectively, and the body is connected with the first and second joint blocks by a fastening members, respectively.

According to the present invention, the first and second joint blocks are restrained on the guide portion of the support mechanism while being movable in the longitudinal direction, and the fluid device is fixed on the first and second joint blocks. Thus, since the respective joint blocks do not have to be fastened to the support mechanism with the use of the fastening bolts, the number of components, especially the number of the bolts can be greatly reduced, and the number of assembling steps can be decreased.

### BRIEF DESCRIPTION OF THE DRAWINGS

The various features, objects, benefits, and advantages of the present invention will become more apparent upon reading the following detailed description of the preferred embodiment(s) along with the appended claims in conjunction with the drawings, wherein like reference numerals identify like components throughout, and:

FIG. 1A is a plan view showing a first embodiment of a fluid control system according to the present invention;

FIG. 1B is a front view of the fluid control system in FIG. 1A;

FIG. 2A is a perspective view showing an assembly of the fluid control system in FIG. 1A;

FIG. 2B is a perspective view showing a modification of the assembly of the fluid control system in FIG. 1A;

FIG. 3 is a perspective view showing a support mechanism of the fluid control system in FIG. 1;

FIG. 4A is a perspective view showing a joint block according to a first embodiment of the present invention;

FIG. 4B is a perspective view showing another example of the joint block according to the present invention;

FIG. 5 is a cross-sectional view showing a sealing mechanism between the joint block and a body of a fluid device;

FIG. 6 is a perspective view showing an assembly according to a second embodiment of the fluid control system of the present invention;

FIG. 7 is a perspective view showing a support mechanism of the assembly in FIG. 6;

FIG. 8 is a perspective view showing an assembly according to a third embodiment of the fluid control system of the present invention;

FIG. 9 is a perspective view showing a support mechanism of the assembly in FIG. 8;

FIG. 10 is a perspective view showing a joint block of the assembly in FIG. 8;

FIG. 11 is a perspective view showing an assembly according to a fourth embodiment of the fluid control system of the present invention;

FIG. 12 is a perspective view showing a support mechanism of the assembly in FIG. 11; and

FIG. 13 is a perspective view showing a joint block in FIG. 11.

### DETAILED DESCRIPTION OF THE INVENTION

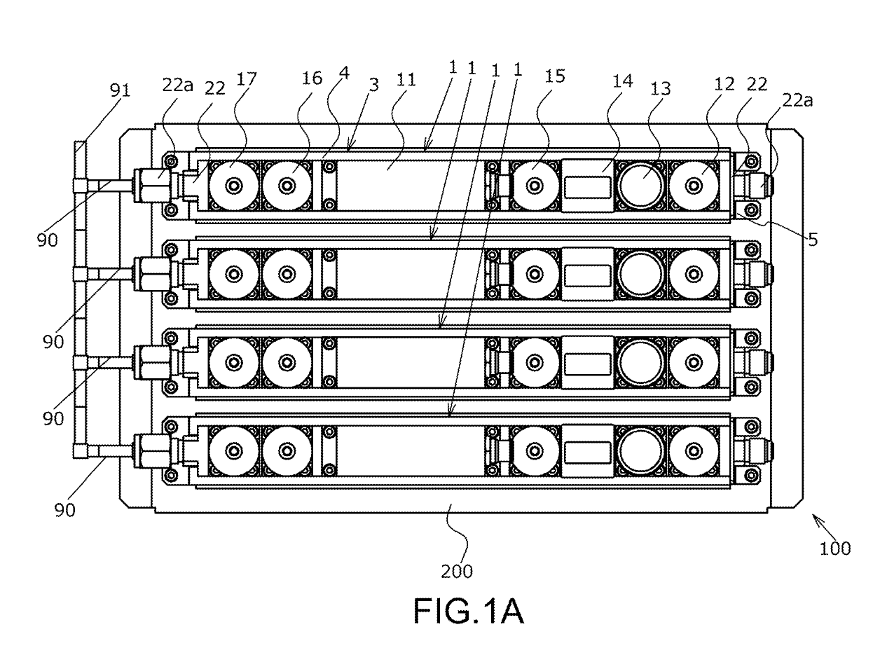

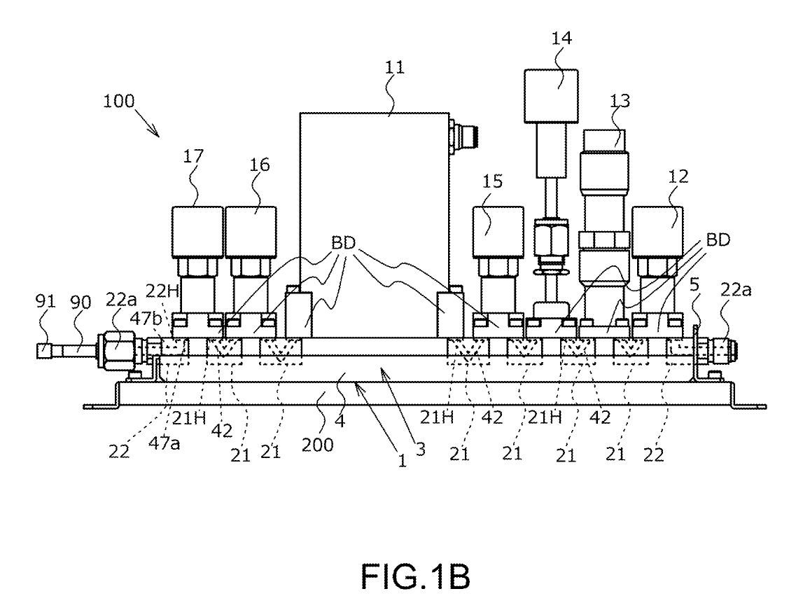

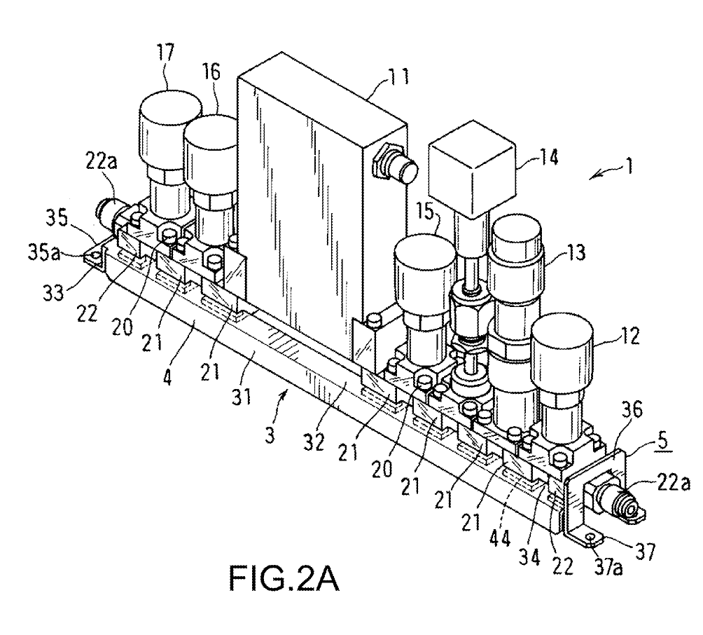

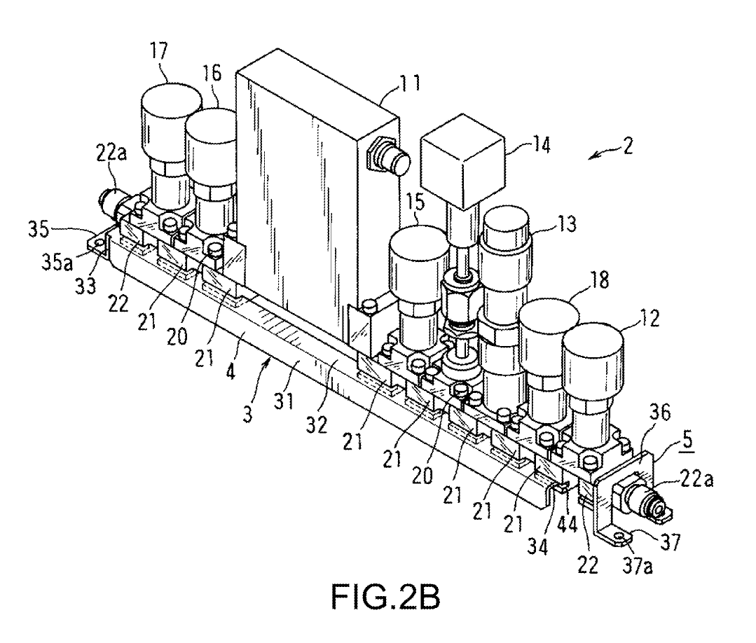

FIG. 1A and FIG. 1B show a fluid control system 100 including a plurality of assemblies 1, that is a first embodiment of a fluid control system according to the present invention. FIG. 2A shows the assembly 1. FIG. 2B shows a modification of the assembly 1, and FIG. 2B will be described later in detail. It is to be noted that, in this specification, as regards upper and lower sides, a fluid device side is determined as the upper side, and a joint block side is determined as a lower side, but the upper and lower sides are just an expediency, and they may be turned upside down or turned to lateral sides and used in this state.

In the fluid control system 100, the four assemblies 1 formed in accordance with respective channels are arranged in parallel on a base plate 200 made of metal. It is to be noted that, in this embodiment, the four assemblies 1 have the same configuration, but they can have configurations different from each other. The fluid control system 100 is usually called an integrated gas system (IGS®), and a box accommodating this fluid control system 100 therein is called a gas box.

In FIGS. 1A and 1B, a right-hand side is an upstream side, a left-hand side is a downstream side, a process gas is supplied to respective pipe joints 22a provided at end portions on the upstream side, and a gas output from the respective pipe joints 22a at end portions on the downstream side is led to common pipe lines 91 through a pipe line 90. The fluid control system 100 is used for control over a fluid adopted in a manufacturing process of, e.g. a semiconductor device, a flat panel display, or a solar panel, controls flow volumes of various kinds of gasses, and supply them to a treatment chamber.

As shown in FIG. 1A to FIG. 2B, the assemblies 1 include a base plate 200, a plurality of (four) support mechanisms 3 fixed to the base plate 200, a joint block 22 on the upstream side, a plurality of (six) joint blocks 21, and a joint block 22 on the downstream side that are supported by each support mechanism 3, and a plurality of fluid devices 11 to 17 installed on these joint blocks 21 and 22 respectively. Reference numeral 11 denotes a mass flow controller (MFC), and reference numerals 12 to 17 designate various types of fluid devices such as a control valve, a pressure gauge and the like. Bodies of the MFC 11 and the various types of control valves 12 to 17 are coupled with the joint blocks 21 or 22 by fastening bolts 20 that pierce through the bodies.

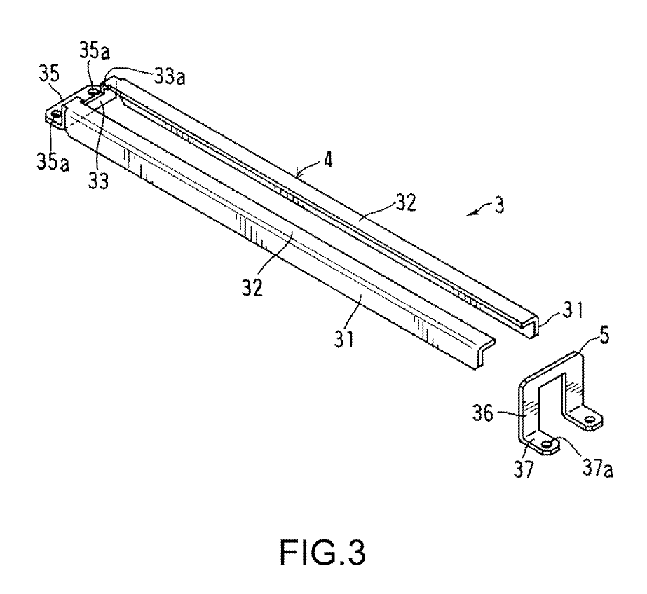

FIG. 3 shows the support mechanism 3 in the fluid control system 100. The support mechanism 3 has a rail member 4 with that the respective joint blocks 21 and 22 engage and a stopper 5 that regulates movements of the respective joint block 21 and 22 in a longitudinal direction of the rail member 4 and prevents the end portion joint block 22 arranged at the end portion on an inlet side from coming off the rail member 4.

The rail member 4 has a pair of sidewalls 31 that are vertically arranged on an installation surface of the base plate 200 and face each other, a pair of upper walls 32 and 32 each of that protrudes from an upper end portion of each sidewall 31 toward the other sidewall 31, and an end wall 33 that couples outlet-side end portions of the pair of sidewalls 31 and 31 with those of the pair of upper walls 32 and 32. The end wall 33 also functions as a stopper in the present invention. The pair of upper walls 32 and 32 function as a guide portion in the present invention.

An outlet-side end surface of the end portion joint block 22 arranged on the outlet side is positioned by the end wall 33. A notch 33a is provided in the end wall 33 so that the pipe joint 22a of the end portion joint block 22 can be protruded toward the front side of the end wall 33 while avoiding interfere with the pipe joint 22a.

A plate-like mounting portion 35 for mounting on the base plate 200 is integrally formed at a lower end portion of the end wall 33 of the rail member 4. As seen from a direction crossing the longitudinal direction of the rail member 4, the end wall 33 is provided at a right angle with the mounting portion 35. Through holes 35a are provided in the mounting portion 35, and screwing bolts into threaded holes provided in the base plate 200 via the through holes 35a enables fixing the rail member 4 to the base plate 200.

The stopper 5 is formed into an L-like shape, and has an abutting portion 36 that faces the end wall 33 of the rail member 4 and a mounting portion 37 that is continuous with the abutting portion 36 at a right angle and mounted on the base plate 200. The abutting portion 36 abuts on an inlet-side end surface of the end portion joint block 22 on the inlet side to regulate movement of this joint block 22. Through holes 37a are provided in the mounting portion 37, and screwing bolts into threaded holes provided in the base plate 200 via the through holes 37a enables mounting the stopper 5 to the base plate 200.

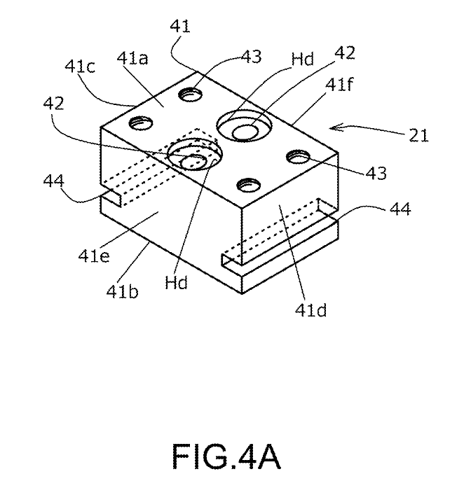

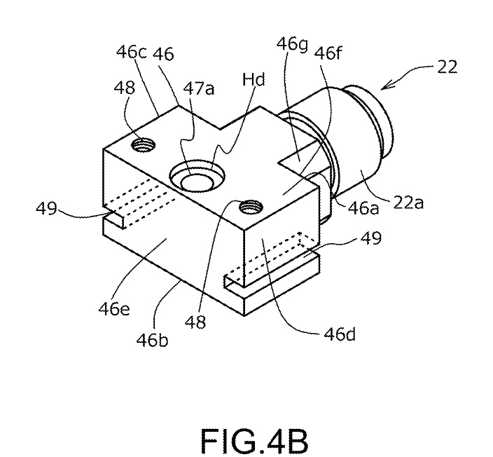

FIG. 4A shows a configuration of the joint block 21.

In the joint block 21, as shown in FIG. 4A, a main body 41 formed into a rectangular parallelepiped block shape defines an upper surface 41a, a bottom surface 41b opposite to the upper surface 41a, side surfaces 41c and 41d extending from the upper surface 41a toward the bottom surface 41b, and both end surfaces 41e and 41f in the longitudinal direction. In the joint block 21, as shown in FIG. 1B, a V-shaped channel 42 is formed, and channel ports opened at two positions in the upper surface 41a apart from each other in the longitudinal direction are defined. It is to be noted that the channel 42 may be a channel extending in a vertical direction and a horizontal direction to the upper surface 41a.

Concave holding portions Hd are formed at outer peripheries of the channel ports of the channel 42 in the joint block 21, and later-described seal members are held in the holding portions Hd respectively.

Further, in the joint block 21, threaded holes 43 that are opened at two positions of the upper surface 41a and extend from the upper surface 41a toward the bottom surface 41b are formed on both sides of the channel port of each channel 42 in a direction crossing the longitudinal direction of the rail member 4. A tip portion of each threaded hole 43 is closed between the upper surface 41a and the bottom surface 41b.

A body BD of each of the fluid devices 12 to 17 has a built-in valve mechanism (not shown) and defines a channel (not shown) having at least two channel ports opened on a bottom surface thereof, and opening/closing or an opening degree of the channel is adjusted by the non-illustrated valve mechanism. A part of the bottom surface of the body BD is installed on the upper surface 41a of the joint block 21, each channel port opened on the bottom surface of the body BD abuts against one channel port of the channel 42 opened on the upper surface 41a of the joint block 21, and a fastening bolt 20 is screwed into each threaded hole 43 through the body BD, thereby coupling the body BD with the joint block 21. At the same time, as will be described later, the seal member is pressed by fastening force of the fastening bolt 20, and a space between the channel on the body BD side and the channel 42 of the joint block 21 is sealed.

Groove portions 44 extending in the longitudinal direction of the rail member 4 are formed in both the side surfaces 41c and 41d of the joint block 21 at positions corresponding to each other, respectively. The groove portions 44 function as an engagement portion of the present invention. The threaded holes 43 are formed at positions overlaying the groove portions 44 in plan view.

FIG. 4B shows a configuration of the joint block 22.

A main body 46 of the joint block 22 defines an upper surface 46a, a bottom surface 46b opposite to the upper surface 46a, side surfaces 46c and 46d extending from the upper surface 46a toward the bottom surface 46b, both end surfaces 46e and 46f in the longitudinal direction, and a protruding portion 46g that protrudes from the end surface 46f. The pipe joint 22a is provided at a tip portion of the protruding portion 46g.

In the main body 46 of the joint block 22, a vertical channel 47a that extends from the upper surface 46a toward the bottom surface 46b and a horizontal channel 47b (see FIG. 1B) that communicates with the vertical channel 47a in the main body 46, extends in the longitudinal direction, and is opened on an end surface of the pipe joint 22a are formed. The vertical channel 47a is opened on the upper surface 46a to forma channel port. A concave holding portion Hd is formed at an outer periphery of this channel port, and a later-described seal member is held in this holding portion Hd. The horizontal channel 47b communicates with the pipe joint 22a.

In the joint block 22, threaded holes 48 are formed on both sides of the channel port of the vertical channel 47a in the direction crossing the longitudinal direction. A bottom end portion of each threaded holes 48 is occluded between the upper surface 46a and the bottom surface 46b.

Groove portions 49 extending in the longitudinal direction are formed in both the side surfaces 46c and 46d of the joint block 22 at positions corresponding to each other, respectively. The groove portions 49 function as an engagement portion of the present invention. The threaded holes 48 are formed at positions overlaying the groove portions 49 in plan view.

A part of the bottom surface of the body BD of each of the fluid device 12 and 17 is installed on the upper surface 46a of the joint block 22, each channel port opened on the bottom surface of the body BD abuts against the channel port of the vertical channel 47a formed on the upper surface 46a of the joint block 22, and the fastening bolt 20 is screwed into each threaded hole 48 through the body BD, thereby coupling the body BD with the joint block 22. At the same time, as will be described later, the seal member is pressed by the fastening force of the fastening bolt 20, and a space between the channel on the body BD side and the vertical channel 47a of the joint block 22 is sealed.

The groove portions 44 and 49 of the joint blocks 21 and 22 are fitted on the upper walls 32 and 32 of the rail member 4 of the support mechanism 3, respectively. Further, the rail member 4 can receive the groove portions 44 and 49 of the joint blocks 21 and 22 from its opening end in the longitudinal direction. When the groove portions 44 and 49 of the joint blocks 21 and 22 are fitted on the upper walls 32 and 32 of the rail member 4, the joint blocks 21 and 22 can move in the longitudinal direction and, on the other hand, the joint blocks 21 and 22 are supported by the support mechanism 3 and also restrained on the support mechanism 3.

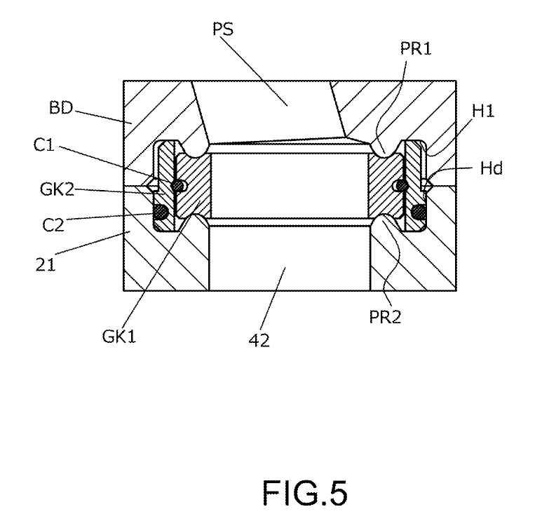

FIG. 5 shows an example of a sealing structure between the joint block 21 or 22 and the body BD of each of the fluid devices 12 to 17. It is to be noted that the sealing structure shown in FIG. 5 is likewise applied between the joint block 22 and the body BD.

As shown in FIG. 5, the body BD defines a channel PS, and the channel PS has a channel port opened on a bottom surface of the body BD. The channel 42 of the joint block 21 has each channel port opened on the upper surface of the joint block 21 as described above. In the body BD, a holding portion H1 to hold the seal member is formed at an outer periphery of the channel port of the channel PS. An annular protrusion PR1 arranged concentrically with the holding portion H1 is formed on a bottom surface of the holding portion H1 of the body BD, and an annular protrusion PR2 arranged concentrically with the holding portion Hd is formed on a bottom surface of the holding portion Hd of the joint block 21.

An annular seal member GK1 and an annular seal member GK2 provided on an outer peripheral side of the seal member GK1 are provided between the holding portion Hd of the joint block 21 and the holding portion H1 of the body BD. A C-ring C1 is fitted in a groove formed on an outer peripheral surface of the seal member GK1. A C-ring C2 is fitted in a groove formed on an outer peripheral surface of the seal member GK2. Alternatively, O-rings can be used in place of the C-rings C1, C2.

Although he joint block 21 and the body BD are coupled with each other by the fastening force of the fastening bolts 20, when the fastening force of the fastening bolts 20 acts between the body BD and the joint block 21, the protrusion PR1 and the protrusion PR2 press the seal member GK1 from the upper and lower sides. Consequently, the space between the channel PS of the body BD and the channel 42 of the joint block 21 is sealed.

As the seal members GK1 and GK2, there are, e.g., gaskets made of metal or resin.

As the gasket, there are soft gaskets, semimetal gaskets, metal gaskets, and others. Specifically, the following gaskets are preferably used.

### (1) Soft Gaskets

Rubber O-rings

Rubber sheets (for flat faces)

Joint sheets

Expanded graphite sheets

PTFE sheets

PTFE jacket type

### (2) Semimetal Gaskets

Spiral-wound gaskets

Metal jacket gaskets

### (3) Metal Gaskets

Solid-metal flat gaskets

Metal hollow O-rings

Ring joints

An assembling procedure of the assembly 1 having the above-described configuration will now be described.

As one of assembling methods, the joint blocks 21 and 22 are decisively arranged at predetermined positions on a reference plane, and the fluid devices 11 to 17 are installed on the joint blocks 21 and 22 respectively. Further, the joint blocks 21 and 22 and the bodies BD of the fluid devices 11 to 17 are fastened with the use of the fastening bolts, whereby the joint blocks 21 and 22 are coupled with the fluid devices 11 to 17. The groove portions 44 and 49 of the joint blocks 21 and 22 of a subassembly in this state are fitted onto the rail member 4 of the support mechanism 3. Consequently, the assembly 1 is brought to completion. This assembly 1 is installed on the base plate 200, and the mounting portion 35 of the rail member 4 and the mounting portion 37 of the stopper 5 are mounted on the base plate 200.

As another assembling method, the rail member 4 may be mounted on the base plate 200, and the joint block 22, the joint block 21, and the fluid devices 11 to 17 may be coupled with the use of the bolts 20 while fitting the joint block 22 and the joint blocks 21 to the rail member 4 in a predetermined order. Lastly, the mounting portion 37 of the stopper 5 is mounted on the base plate 200, thereby completing the assembling.

An assembly 2 shown in FIG. 2B is formed by adding a fluid device 18 to the assembly 1 shown in FIG. 1, a total length of the assembly 2 is longer than that of the assembly 1, and a mounting position of the stopper 5 of the assembly 2 is different from that of the assembly 1. Since a length of the assembly varies depending on the number of the fluid devices used in each assembly, a length of the rail member 4 may be changed in response to this change, but the length of the rail member 4 may be fixed and a mounting position of the stopper 5 on the base plate 200 may be simply changed in correspondence with an assembly having a short length to cope with a difference in total length of the respective assemblies.

### Other Embodiments

Some of other embodiments will now be described hereinafter. It is to be noted that an end portion of one assembly 1 in a fluid control system alone will be described below, and a detail description of the assembly 1 will be omitted.

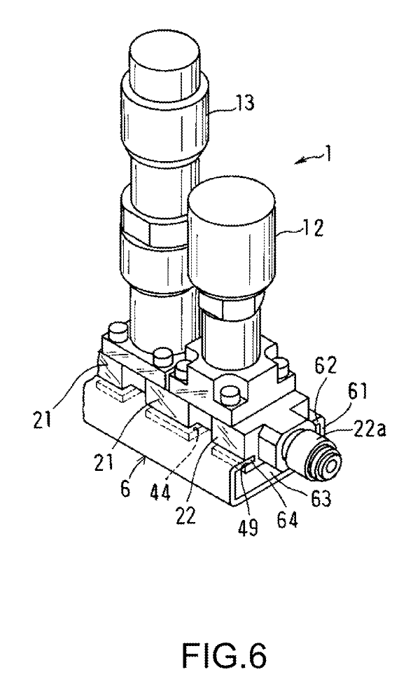

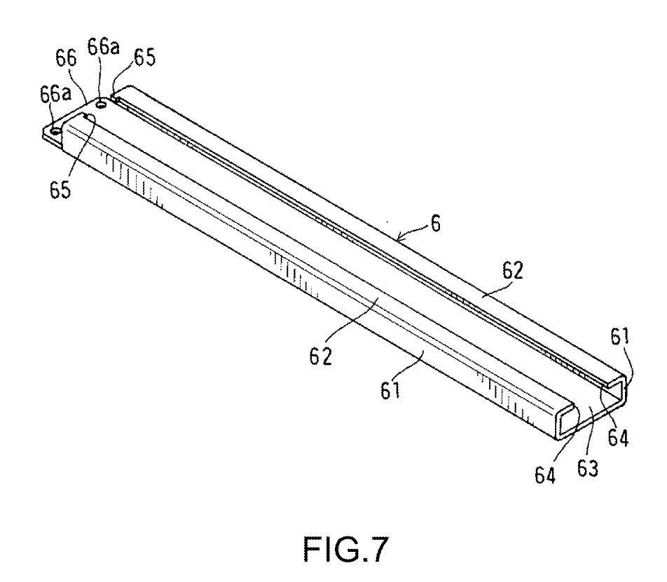

FIG. 6 and FIG. 7 show a second embodiment of the fluid control system and the joint block for the fluid device according to the present invention in that joint blocks 21 and 22 are the same as those described above, groove portions 44 and 49 as engagement portions are provided, and a rail member 6 that supports these portions is different.

As shown in FIG. 6 and FIG. 7, the rail member 6 according to the second embodiment has a pair of sidewalls 61 that are vertical to a top surface of a base plate 200 and extend to be parallel to each other, a pair of upper walls 62 that extend from an upper end portion of each sidewall 61 toward the other sidewall 61 to be parallel to the surface of the vertical base plate 200 and face each with a predetermined gap therebetween, and a lower wall 63 that couples lower end portions of the pair of sidewalls 61 with each other. The sidewalls 61, the upper walls 62, and the lower wall 63 have the same thickness.

The joint blocks 21 and 22 are the same as those shown in FIG. 4A and FIG. 4B, and the groove portions 44 and 49 are formed in the joint blocks 21 and 22 respectively. Furthermore, like the first embodiment, inner edge portions of the upper walls 62 of the rail member 6 are used as convex portions 64 as engagement portions that slidably engage with the groove portions 44 and 49 of the joint blocks 21 and 22. The rail member 6 and a stopper 5 shown in FIG. 3 form a support mechanism 3.

An end wall is omitted, and a protruding portion (a positioning portion) 65 that positions an outlet-side end surface of the end portion joint block 22 arranged on an outlet side is provided at an outlet-side end portion of each upper wall 62. Moreover, an outlet-side end portion of the lower wall 63 is protruded outward in a length direction to be longer than the upper walls 62, and this portion serves as a mounting portion 66 fixed to the base plate 200.

Through holes 66a are provided in the mounting portion 66, and the rail member 6 can be fixed to the base plate 200 by setting the through holes 66a to threaded holes provided in the base plate 200 and screwing bolts into the threaded holes.

In the second embodiment, when the groove portions 44 and 49 of the respective joint blocks 21 and 22 engage with the corresponding convex portions 64 of the upper walls 62 of the rail member 6, the respective joint blocks 21 and 22 are supported by the rail member 6. When the convex portions 64 engage with the groove portions 44 and 49 in a state where portions of the respective joint blocks 21 and 22 below the groove portions 44 and 49 are accommodated between the pair of sidewalls 61 of the rail member 6, the joint blocks 21 and 22 can move to appropriate positions on the rail member 6 in the longitudinal direction without changing their arrangement heights. Since the groove portions 44 and 49 on both the side surfaces engage with the convex portions 64 of the rail member 6, the respective joint blocks 21 and 22 are prevented from coming off the rail member 6 upward. In this manner, the trouble of assembling each assembly 1 can be saved without increasing the number of components.

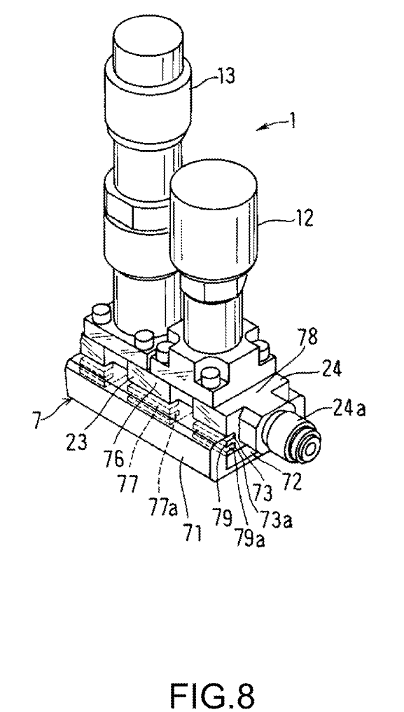

FIG. 8 to FIG. 10 show a third embodiment of a fluid control system and joint blocks according to the present invention in that engagement portions of joint blocks 23 and 24 are groove portions 77 and 79 and engagement portions of a rail member 7 are convex portions 73.

As shown in FIG. 8, one assembly 1 has a plurality of fluid devices 12 and 13, a plurality of intermediate joint blocks 23 and two end portion joint blocks 24 each having a pipe joint 24a, and a rail member 7 that supports the joint blocks 23 and 24.

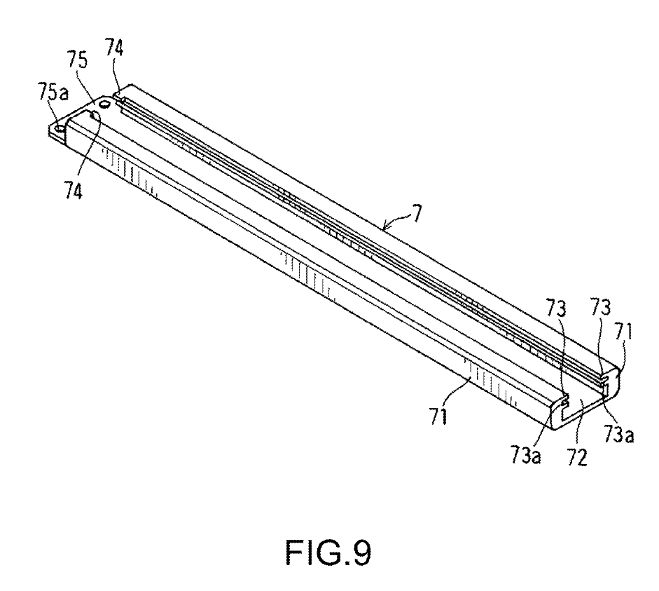

As shown in FIG. 8 and FIG. 9, the rail member 7 according to the third embodiment has a pair of sidewalls 71 that are vertical to a top surface of a base plate 200 and extend to be parallel to each other, a lower wall 72 that couples lower end portions of the pair of sidewalls 71 with each other, and a pair of convex portions 73 each having a square cross portion that vertically extend from an upper end portion of an inner side surface of each sidewall 71 toward the other sidewall and face each other with a predetermined gap therebetween.

Each sidewall 71 has a larger wall thickness than those of the lower wall 72 and each sidewall 61 in the second embodiment. A thickness of each convex portion 73 is substantially equal to a thickness of the sidewall 71 and approximately triple a thickness of each upper wall 62 in the second embodiment.

The rail member 7 and a stopper 5 shown in FIG. 3 form a support mechanism 3.

A groove portion 73a having a square cross portion is formed in an intermediate part between upper and lower sides of each convex portion 73 over the entire length. The groove portion 73a reaches an inner sidewall of the sidewall 71.

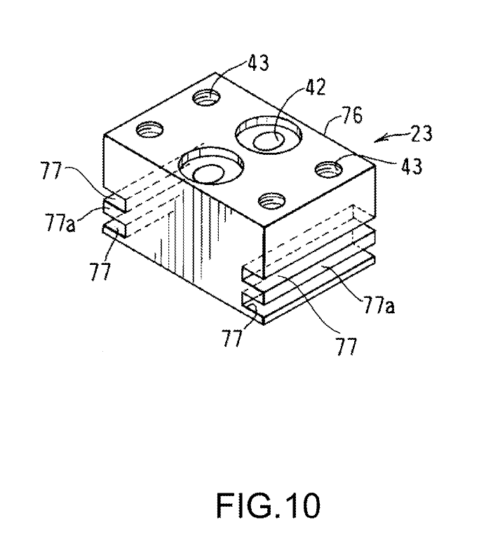

In the joint block 23, as shown in FIG. 10, as a basic configuration, like the joint block 21 in the first embodiment, a V-shaped channel 42 that allows channels of the fluid devices 12 to 18 to communicate with each other is formed in a main body 76 having a rectangular parallelepiped block shape, threaded holes 43 that are opened on an upper surface of the main body 76 and used for mounting the fluid devices 12 to 18 are provided in the main body 76, and through holes used as bolt insertion holes are not provided.

Additionally, as a configuration to realize slidable engagement with the convex portions 73 of the rail member 7, groove portions 77 corresponding to the convex portions 73 of the rail member 7 are formed in the main body 76 of the joint block 23, and a convex portion 77a that is fitted in the groove portion 73a of the rail member 7 is provided at an intermediate part between upper and lower sides of each groove bottom.

In the joint block 24, as a basic configuration, like the end portion joint block 22 according to the first embodiment, an L-shaped channel (not shown) that allows the channels of the fluid devices 12 to 18 to communicate with each other is formed in a main body 78 having a rectangular parallelepiped block shape, threaded holes 48 that are opened on an upper surface of the main body 78 and used for mounting the fluid devices 12 to 18 are provided in the main body 78, and through holes used as bolt insertion holes are not provided.

Further, as a configuration that realizes slidable engagement with the convex portions 73 of the rail member 7, groove portions 79 corresponding to the convex portions 73 of the rail member 7 are formed in the main body 78 of the joint block 24, and a convex portion 79a that is fitted in the groove portion 73a of each convex portion 73 of the rail member 7 is provided at an intermediate part between upper and lower sides of each groove bottom.

An end wall of the rail member 7 is omitted, and a protruding portion (a positioning portion) 74 that positions an outlet-side end surface of the end portion joint block 24 arranged on an outlet side is provided at an outlet-side end portion of an upper surface of each sidewall 71 of the rail member 7. Moreover, an outlet-side end portion of the lower wall 72 is protruded to an outer side of the sidewall 71, and this portion serves as a mounting portion 75 fixed to the base plate 200.

Through holes 75a are provided in the mounting portion 75, and the rail member 7 can be fixed to the base plate 200 by setting the through holes 75a to threaded holes provided in the base plate 200 and screwing bolts into the threaded holes.

In the third embodiment, when the groove portions 77 and 79 of the respective joint blocks 23 and 24 engage with the corresponding convex portions 73 of the rail member 7, the respective joint blocks 23 and 24 are supported by the rail member 7. When the convex portions 73 engage with the groove portions 77 and 79 in a state where portions of the respective joint blocks 23 and 24 below the groove portions 77 and 79 are accommodated between the pair of sidewalls 71 of the rail member 7, the joint blocks 23 and 24 can move to appropriate positions on the rail member in the longitudinal direction without changing their arrangement heights. Since the groove portions 77 and 79 on both the side surfaces engage with the convex portions 73 of the rail member 7, the respective joint blocks 23 and 24 are prevented from coming off the rail member 7 upward. In this manner, the trouble of assembling each assembly 1 can be saved without increasing the number of components.

It is to be noted that the groove portions 73a provided in the convex portions 73 of the rail member 7 and the convex portions 77a and 79a of the groove portions 77 and 79 of the joint blocks 23 and 24 corresponding thereto may be omitted. Furthermore, in the above description, the groove portions 73a provided in the convex portions 73 of the rail member 7 reach the inner side surfaces of the sidewalls 71, and the convex portions 73 have a pair of upper and lower convex shapes each having square cross section, but a depth of the groove portions 73a may be shallower or deeper than that shown in the drawing.

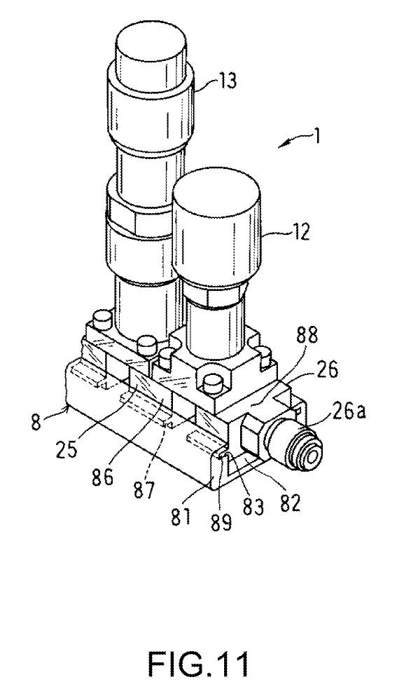

FIG. 11 to FIG. 13 show a fourth embodiment of a fluid control system and joint blocks for fluid devices according to the present invention in that engagement portions of joint blocks 25 and 26 are convex portions 87 and 89 in place of the groove portions and engagement portions of a rail member 8 are groove portions 83 in place of the convex portions.

As shown in FIG. 11, one assembly 1 has a plurality of fluid devices 12 and 13, a plurality of intermediate joint blocks 25 and two end portion joint blocks 26 each having a pipe joint 26a, and a rail member 8 that supports the joint blocks 25 and 26.

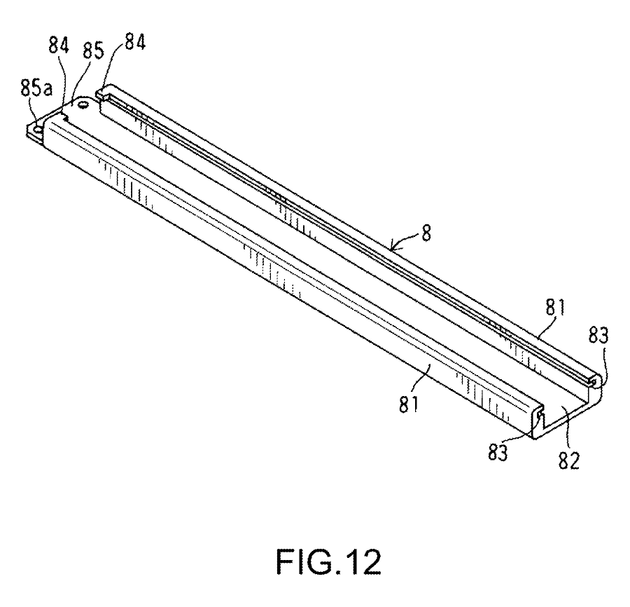

As shown in FIG. 11 and FIG. 12, the rail member 8 according to the fourth embodiment has a pair of sidewalls 81 that are vertical to a top surface of a base plate 200 and extend to be parallel to each other and a lower wall 82 that couples lower end portions of the pair of sidewalls 81 with each other.

Each side wall 81 has a larger wall thickness than that of the lower wall 82, and a groove portions 83 having a square cross portion is provided at an upper end portion of an inner surface of each sidewall 81 over the entire length of each sidewall 81.

The rail member 8 and a stopper 5 shown in FIG. 3 form a support mechanism 3.

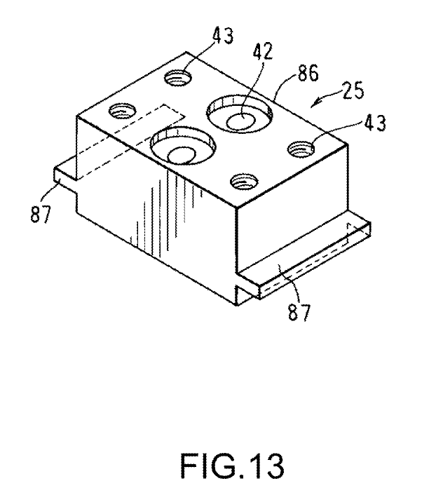

In the joint block 25, as shown in FIG. 13, as a basic configuration, like the joint block 21 according to the first embodiment, a V-shaped channel 42 that allows channels of the fluid devices 11 to 18 to communicate with each other is formed in a main body 86 having a rectangular parallelepiped block shape, threaded holes 43 that are opened on an upper surface of the main body 86 and used for mounting the fluid devices 12 to 18 are provided in the main body 86, and through holes used as bolt insertion holes are not provided.

Additionally, as a configuration to realize slidable engagement with the groove portions 83 of the rail member 8, convex portions 87 corresponding to the groove portions 83 of the rail member 8 are formed in the main body 86 of the joint block 25. Each convex portion 87 is provided at a part close to the lower side of the main body 86.

In the joint block 26, as a basic configuration, like the joint block 22 according to the first embodiment, an L-shaped channel (not shown) that allows the channels of the fluid devices 11 to 18 to communicate with each other is formed in a main body 88 having a rectangular parallelepiped block shape, threaded holes 48 that are opened on an upper surface of the main body 88 and used for mounting the fluid devices 12 to 18 are provided in the main body 88, and through holes used as bolt insertion holes are not provided.

Further, as a configuration that realizes slidable engagement with the groove portions 83 of the rail member 8, convex portions 89 corresponding to the groove portions 83 of the rail member 8 are formed in the main body 88 of the joint block 26. Convex portions 89 are provided at parts close to the lower side of the main body 88.

An end wall of the rail member 8 is omitted, and a protruding portion (positioning portion) 84 that positions an outlet-side end surface of the end portion joint block 26 arranged on an outlet side is provided at an outlet-side end portion of an upper surface of each sidewall 81 of the rail member 8. Moreover, an outlet-side end portion of the lower wall 82 is protruded to an outer side of the sidewall 81, and this portion serves as a mounting portion 85 fixed to the base plate 200.

Through holes 85a are provided in the mounting portion 85, and the rail member 8 can be fixed to the base plate 200 by setting the through holes 85a to threaded holes provided in the base plate 200 and screwing bolts into the threaded holes.

In the fourth embodiment, when the convex portions 87 and 89 of the respective joint blocks 25 and 26 engage with the corresponding groove portions 83 of the rail member 8, the respective joint blocks 25 and 26 are supported by the rail member 8. When the groove portions 83 engage with the convex portions 87 and 89 in a state where lower portions of the respective joint blocks 25 and 26 including the convex portions 87 and 89 are accommodated between the pair of sidewalls 81 of the rail member 8, the joint blocks 25 and 26 can move to appropriate positions on the rail member 8 in the longitudinal direction without changing their arrangement heights. Since the convex portions 87 and 89 on both the side surfaces engage with the groove portions 83 of the rail member 7, the respective joint blocks 25 and 26 are prevented from coming off the rail member 8 upward. In this manner, the trouble of assembling each assembly 1 can be saved without increasing the number of components.

In the foregoing embodiments, although the stopper 5 is provided at one end portion of the rail member in the longitudinal direction, the present invention is not restricted thereto, and the stoppers may be provided on both end sides of the rail member. Although the example where the stopper 5 is provided on the base plate 200 has been described, the present invention is not limited thereto, and the stopper can be detachably provided to the rail member. Furthermore, the stoppers can be detachably provided at arbitrary positions on the rail member on the upstream side and the downstream side.

In the foregoing embodiments, the groove portions and the concave portions are provided on some parts of the side surfaces to serve as the engagement portions in the present invention, but the present invention is not restricted thereto, and the engagement portions can be provided on the bottom surface or the bottom portion, and any other conformation than the groove portions or the convex portions can be adopted.

While the preferred embodiments of the present invention have been described so as to enable one skilled in the art to practice the device of the present invention, it is to be understood that variations and modifications may be employed without departing from the concept and intent of the present invention as defined in the following claims. Accordingly, the preceding description is intended to be exemplary and should not be used to limit the scope of the invention. The scope of the invention should be determined only by reference to the following claims.

What is claimed is:

1. A fluid control system comprising:
first and second joint blocks defining an upper surface, a bottom surface opposite to the upper surface, and a side surface extending from the upper surface toward the bottom surface, also defining a fluid channel with a channel port opened on the upper surface, and have an engagement portion, respectively;
a support mechanism having a guide portion extending in a longitudinal direction, the guide portion being engageable with each of the engagement portions of the first and second joint blocks; and
a fluid device having a body that defines a fluid channel with first and second channel ports opened on a bottom surface thereof,
wherein the engagement portions are engaged with the guide portion of the support mechanism, respectively, so that the first and second joint blocks are restrained on the support mechanism while being movable along the longitudinal direction, and
the body of the fluid device is installed on the upper surfaces of the first and second joint blocks so that the first and second channel ports of the body are communicated with the channel ports in the upper surfaces of the first and second joint blocks, respectively, and the body is connected with the first and second joint blocks by a fastening members, respectively.

2. The fluid control system according to claim 1, further comprising a stopper that regulates movement of the fluid device and the first and second joint blocks, which are connected with each other, in the longitudinal direction.

3. The fluid control system according to claim 2,
wherein the stopper constitutes a part of the support mechanism.

4. The fluid control system according to claim 2,
wherein the stopper is detachably provided at an arbitrary position on the guide portion of the support mechanism.

5. The fluid control system according to claim 1,
wherein the engagement portions of the first and second joint blocks are formed on side surfaces of the joint blocks so as to extend in the longitudinal direction, respectively.

6. The fluid control system according to claim 1,
wherein seal members are arranged between the bottom surface of the body and the upper surfaces of the first and second joint blocks so as to surround the first and second channel ports of the body and the channel ports in the upper surfaces of the first and second joint blocks, which are communicated with each other, and
the seal member is pressed by fastening force of the fastening members.

7. The fluid control system according to claim 6,
wherein the first and second joint block has threaded holes extending from the upper surfaces toward the bottom surfaces, into which the fastening bolts are screwed, respectively, and
the threaded holes are opened on the upper surfaces and has end portions occluded between the upper surfaces and the bottom surfaces, respectively.

8. The fluid control system according to claim 7,
wherein the threaded holes of the first and second joint blocks are formed on both sides of each of the channel ports in a direction orthogonal to the longitudinal direction.

9. The fluid control system according to claim 8,
wherein at least one of the first and second joint blocks has first and second channel ports at two positions apart from each other in the longitudinal direction on the upper surface, and the threaded holes are formed on both sides of the first and second channel ports in the direction orthogonal to the longitudinal direction.

10. The fluid control system according to claim 8,
wherein at least one of the first and second joint blocks has a first channel port opened on the upper surface and a second channel port opened on one of both end surfaces in the longitudinal direction, and
the threaded holes are formed on both sides of the first channel port in the direction orthogonal to the longitudinal direction.

11. The fluid control system according to claim 1,
wherein the support mechanism is formed so as to enable receiving each of the first and second joint blocks from at least one end portion of the guide portion in the longitudinal direction.

12. The fluid control system according to claim 1, further comprising:
a plurality of assemblies having the first and second joint blocks which are restrained on the support mechanism and have the fluid device installed thereon; and
a base plate on which the plurality of assemblies are aligned and fixed.

13. The fluid control system according to claim 7,
wherein the engagement portions of the joint blocks are formed by groove portions, and the guide portions of the support mechanism are formed by convex portions.

14. The fluid control system according to claim 13,
wherein the support mechanism comprises:
a pair of sidewalls that face each other and extend in the longitudinal direction;
a pair of upper walls that extend from an upper end portion of one of the pair of sidewalls toward the other sidewall and face each other to interpose a predetermined gap therebetween; and
an end wall that couples outlet-side end potions of the pair of sidewalls with counterparts of the pair of upper walls.

15. The fluid control system according to claim 13,
wherein the groove portions forming the engagement portions of the joint blocks are formed so as to overlap the threaded holes in plan view.

16. The fluid control system according to claim 1,
wherein the engagement portions of the joint blocks are formed by convex portions, and the guide portions of the support mechanism are formed by groove portions.

17. The fluid control system according to claim 17,
wherein the support mechanism comprises:
a pair of sidewalls that face each other and extend in the longitudinal direction;
a pair of upper walls that extend from an upper end portion of one of the pair of sidewalls toward the other sidewall and face each other to interpose a predetermined gap therebetween; and
a lower wall that couples lower end portions of the pair of sidewalls with each other.

18. A joint block for a fluid control system, that defines an upper surface and a bottom surface that face each other and a side surface that extends from the upper surface toward the bottom surface, and also defines a fluid channel,
wherein the upper surface defines an installation surface on which a part of a body of a fluid device is installed,
the fluid channel of the joint block has two channel ports that are opened at two positions on the upper surface apart from each other in a longitudinal direction,
threaded holes formed on both sides of the two channel ports are opened on the upper surface in a direction crossing the longitudinal direction,
each of the threaded holes is formed in a direction perpendicular to the upper surface so as to be occluded halfway, and
an engagement portion that engages with the other member to enable guiding is formed on the side surface.

19. A joint block for a fluid control system, that defines an upper surface and a bottom surface that face each other and a side surface that extends from the upper surface toward the bottom surface, and also defines a fluid channel,
wherein the upper surface defines an installation surface on that a part of a body of a fluid device is installed,
the fluid channel of the joint block has a channel port opened on the upper surface and a channel port opened on an end surface in the longitudinal direction,
threaded holes formed on both sides of the channel port opened on the upper surface are opened the upper surface in a direction crossing the longitudinal direction,
each of the threaded holes is formed in a direction perpendicular to the upper surface so as to be occluded halfway, and
an engagement portion that engages with the other member to enable guiding is formed on the side surface.
